(19) United States
(12) Patent Application Publication
(10) Pub. No.: US 2026/0338550 A1
(43) Pub. Date: Oct. 29, 2026

(54) MEASUREMENT DEVICE

(71) Applicant: TOPCON CORPORATION, Itabashi-ku, Tokyo (JP)

(72) Inventors: Yasuhisa KANEDA, Itabashi-ku, Tokyo (JP); Takeo AOKI, Itabashi-ku, Tokyo (JP)

(73) Assignee: TOPCON CORPORATION, Itabashi-ku, Tokyo (JP)

(21) Appl. No.: 19/113,032

(22) PCT Filed: Sep. 19, 2023
(86) PCT No.: PCT/JP2023/033966

§ 371 Date: Mar. 19, 2025

(30) Foreign Application Priority Data
Sep. 20, 2022 (JP) 2022-149137

(51) Int. Cl. G01C 15/00; G01D 11/24; G01D 11/30

(52) U.S. Cl. CPC G01C 15/002; G01D 11/245; G01D 11/30

(57) ABSTRACT

There is provided a measurement device that is easy to take out from a housing case and can prevent a lower back pain. A measurement device includes: two handles (70,71) that project from a measurement device main body (2), and the handle (70) and the handle (71) project toward a back face side at a range of 40 to 45 degrees of angles to the left and the right, respectively, from a horizontal direction center in a standing state of the measurement device main body (2), and along a radial direction from the horizontal direction, a swelled part (80) that swells toward (80) a frontmost side is formed on a front face side opposite to the handles (70,71), and in the standing state, the handles (70,71) and batteries (38,39) have different positions in an upper/lower direction with the swelled part (80) serving as a reference.

### TECHNICAL FIELD

The present invention relates to a measurement device with handles.

### BACKGROUND ART

Conventionally, measurement devices that use laser light are known, and measurement devices are used in various cases to receive reflection light of emitted laser light to acquire spatial position information of a target, and irradiate a target with laser light to define a reference plane or a reference line of civil engineering and construction.

This measurement device frequently uses a tripod since horizontal and vertical levels are important, and a measurer places the measurement device on the tripod holding handles attached to the measurement device and fixes and uses the tripod and the measurement device.

Thus, it is necessary to fix a heavy measurement device onto a tall tripod, and therefore there is proposed a measurement device that is easy to hold. For example, handles of a measurement device according to PTL 1 each include a grip part that is gripped by a hand and fingers, and a support arm part attached to a housing to support the grip part, and a curved part that matches with the shape of a belly of a thumb is formed on an upper face of the support arm part. Consequently, by gripping the handle with the four fingers except the thumb, placing the forefinger in contact with a lower face of the support arm part, supporting the support arm part from below with the forefinger, and sandwiching the support arm part closer to the center of mass than the grip part in a horizontal direction with the forefinger and the thumb, it is possible to easily hold a survey instrument.

### CITATION LIST

### Patent Literature

### [PTL 1]

Japanese Patent Application Publication No. 2018-146395

### SUMMARY OF INVENTION

### Technical Problem

However, although PTL 1 is superior in holding the measurement device in a state where the measurer stands, not only this measurement device according to PTL 1, but also conventional measurement devices do not take into account a physical burden on a body at an instant at which the measurement device is taken out from a housing case put on a floor or the like. That is, for example, the back is likely to be strained when the measurer suddenly changes a posture or when the measurer holds an object bending forward, and then an instant at which the measurer lifts the measurement device may be a cause that leads to a lower back pain.

The present invention solves such a problem, and an object of the present invention is to provide a measurement device that is easy to take out from a housing case, and reduces a physical burden on a body such as a cause of a lower back pain.

### Solution to Problem

The above problem is solved by a measurement device that includes: a measurement device main body that includes a laser light emitting unit that emits laser light for measurement; a base part that rotatably supports the measurement device main body in a horizontal direction; and handles that project from the measurement device main body, and in which the handles project from left and right sides of a back face along a radial direction from a center of the horizontal direction in a standing state of the measurement device main body, and each handle is arranged at angle ranges of 40-45 degrees from the center of the horizontal direction, a swelled part that swells toward a frontmost side is formed on a front face side opposite to the handles of the measurement device main body, and in the standing state, the handles and batteries that apply voltages to the laser light emitting unit have different positions in an upper/lower direction with the swelled part serving as a reference.

According to the above invention, in the measurement device that performs measurement using laser light, the handles project toward the back face side along the radial direction from the horizontal direction center in the standing state of the measurement device main body. Hence, when a lid of a housing case is opened in a state where the measurement device is laid in the housing case with the front face side facing downward, the handles project upward. Consequently, when the handles are gripped to take out the measurement device from the housing case, the handles are located above, so that it is possible to grip the handles without deeply bending forward. Consequently, it is possible to reduce a physical burden on a waist when the waist is bent forward. That is, the “back face” described here means a face that can be visually checked from above in a state where the measurement device is laid with the front face facing downward.

Moreover, these handles are arranged on both of left and right at the ranges of 40 to 45 degrees from the center of the measurement device main body. Consequently, when the handles of the measurement device that is generally narrower than shoulder widths are gripped, this arrangement functions to make wrists hardly bend and prevent the wrists from bending forward or bending backward, so that it is possible to effectively exhibit a gripping force.

Furthermore, the swelled part that swells toward the frontmost side is formed on the front face side opposite to the handles of the measurement device main body, and, moreover, in the standing state, the handles and the batteries are arranged relatively reversely on the upper side and the lower side, respectively, with the swelled part serving as a reference. Consequently, when the handles are lifted to take out the measurement device from the case in a state where the measurement device is laid with the front face side facing downward, a force acts with the heavy battery side facing downward, the swelled part serves as a pivot point to turn the handle side upward according to the principle of leverage and make the handles easy to lift, so that it is possible to suppress a force in a bending forward state.

Furthermore, preferably, the front face side of the upper face of the measurement device main body in the standing state is a curved inclined face that inclines downward and has a convex shape outward.

Consequently, when the handle side (upper face side) is turned upward using the swelled part as the pivot point as described above to take out from the housing case the measurement device laid in the housing case with the front face side facing downward, it is possible to prevent the measurement device main body from getting caught by the housing case, and smoothly take out the measurement device from the housing case.

Furthermore, preferably, the measurement device main body includes a lens barrel part at which the laser light emitting unit is arranged, and a bracket part that rotatably supports the lens barrel part in a vertical direction, the lens barrel part and the bracket part have faces that continue to a front face side around a boundary between the lens barrel part and the bracket part, and a continuous pattern is applied across the lens barrel part and the bracket part.

Consequently, the lens barrel part and the bracket part have the faces that continue to the front face side around the boundary between the lens barrel part and the bracket part, so that it is possible to prevent a situation that the main body gets caught by other members in the case.

In this regard, although such a shape makes it difficult to visually check the boundary between the lens barrel part and the bracket part when the device is seen from afar at a time of a remote operation or the like, and grasp a motion of the lens barrel part, the continuous pattern is applied across the lens barrel part and the bracket part in the present invention, so that, when the lens barrel rotates, the continuous pattern is misaligned and makes the motion to easy to grasp.

Furthermore, preferably, the batteries are arranged just below the respective handles on the left and the right in the standing state.

Consequently, it is possible to easily hold the measurement device by shifting the center of mass toward the handle side.

Furthermore, preferably, dent parts that serve as guides for guiding hands wearing gloves to the handles are formed on left and right side faces of the measurement device main body, and the dent parts have a height matching four fingers except thumbs with the gloves on in the standing state, and are arranged across a center part and an upper side of the measurement device main body.

Consequently, a measurer is guided to the dent parts having spatial margins, and grips the center parts to the upper sides (i.e., positions far apart from the batteries) of the handles. Consequently, when the laid measurement device is taken out from the housing case as described above, the swelled part serves as the pivot point, and makes the handle side to easily turn upward more according to the principle of leverage.

### Advantageous Effects of Invention

As described above, according to the present invention, it is possible to provide a measurement device that is easy to take out from a housing case, and reduces a physical burden on a body such as a cause of a lower back pain.

### BRIEF DESCRIPTION OF DRAWINGS

FIG. 1 is a schematic front view illustrating a use state of a measurement device according to an embodiment of the present invention.

FIG. 2 is a front view of the measurement device according to the embodiment of the present invention.

FIG. 3 is a back view of the measurement device in FIG. 2.

FIG. 4 is a plan view of the measurement device in FIG. 2 where dashed-dotted lines indicate virtual lines.

FIG. 5 is a bottom view of the measurement device in FIG. 2 where a dashed-dotted line indicates a virtual line.

FIG. 6 is a right side view of the measurement device in FIG. 2.

FIG. 7 is a left side view of the measurement device in FIG. 2.

FIG. 8 is a perspective view illustrating a front face, a planar face, and a right side face of the measurement device in FIG. 2.

FIG. 9 is a perspective view illustrating a back face, a bottom face, and a left side face of the measurement device in FIG. 2.

FIG. 10 is a view illustrating an example of a state where a lid of a housing case is opened and the measurement device is exposed.

FIG. 11 is a view illustrating that the measurement device in FIG. 10 is about to be taken out from the housing case.

FIG. 12 is a view illustrating a movable range of a wrist in a fist state, FIG. 12(a) illustrates that the wrist is bent forward, FIG. 12(b) is a view illustrating that the wrist is not bent, and FIG. 12(c) is a view illustrating that the wrist is bent backward.

FIG. 13 is a view of the measurement device laid flat in the housing case in FIG. 10.

FIG. 14 is a view for describing a continuous pattern, FIG. 14(A) is a non-driven state, and FIG. 14(B) is a view illustrating that the lens barrel part 50 is rotated downward.

FIG. 15 is a front view illustrating that an example of modifiable parts of the measurement device in FIG. 2 are indicated by broken lines.

FIG. 16 is a back view of the measurement device in FIG. 15.

FIG. 17 is a plan view of the measurement device in FIG. 15.

FIG. 18 is a bottom view of the measurement device in FIG. 15.

FIG. 19 is a right side view of the measurement device in FIG. 15.

FIG. 20 is a left side view of the measurement device in FIG. 15.

FIG. 21 is a perspective view illustrating a front face, a planar face, and a right side face of the measurement device in FIG. 15.

FIG. 22 is a perspective view illustrating a back face, a bottom face, and a left side face of the measurement device in FIG. 15.

FIG. 23 is a perspective view of the measurement device according to a modified example of the embodiment of the present invention.

FIG. 24 is a right side view of the measurement device in FIG. 23.

### DESCRIPTION OF EMBODIMENTS

Hereinafter, a preferred embodiment of the present invention will be described in detail with reference to the drawings.

Note that, although the embodiment described below is a suitable specific example of the present invention, and therefore various technically preferable limitations are added thereto, the scope of the present invention is not limited to this embodiment unless it is described in the following description that a particular limitation is added to the present invention. Furthermore, the same reference numerals assigned in each drawing denotes the same component.

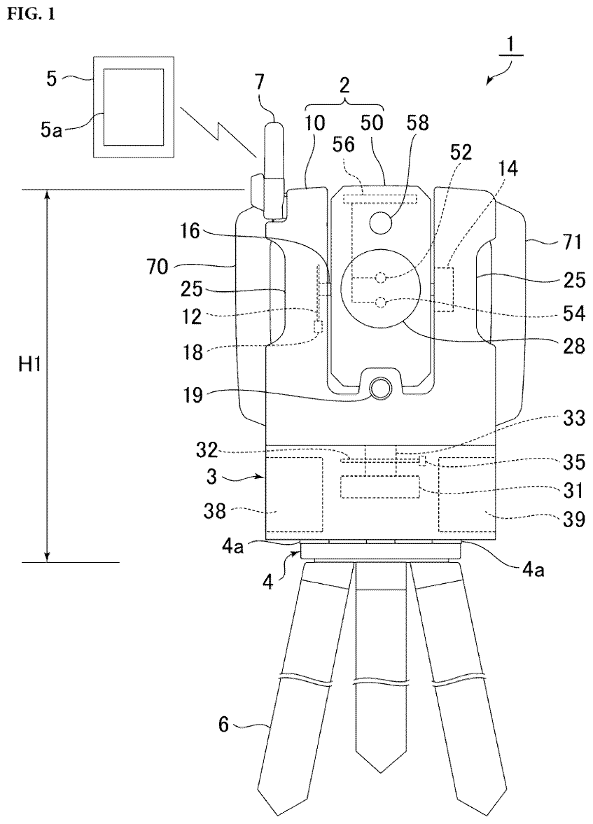

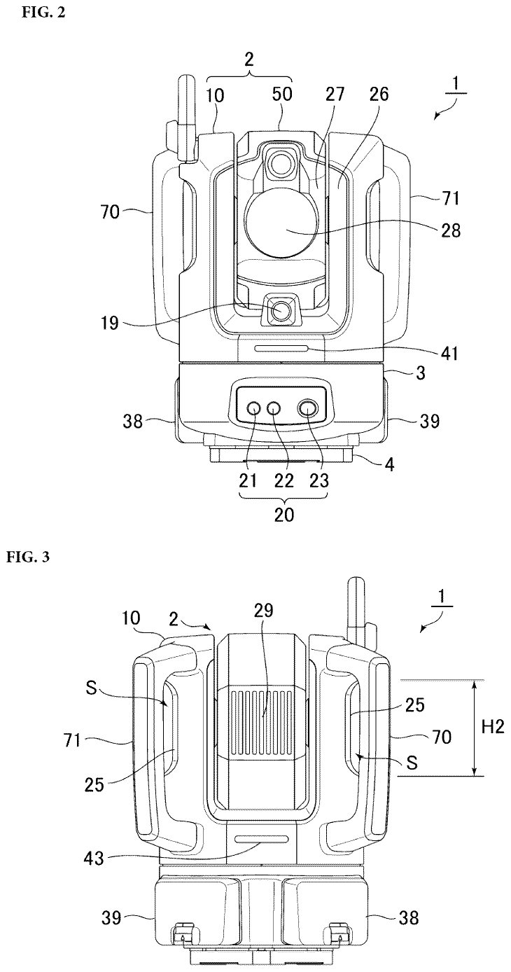

FIGS. 1 to 9 illustrate a measurement device 1 according to the embodiment of the present invention. First, the measurement device 1 will be described with reference mainly to FIG. 1 that is a schematic front view illustrating a use state, and to FIGS. 2 to 9 as appropriate. Note that a “front face” described hereinafter is a face on which a wide-angle camera 19 in FIG. 1 is located, or a face on which a window part 28 in a non-driven state is located in the present embodiment.

The measurement device 1 in the drawings is a device that acquires spatial position information of a target using emitted laser light, is superior in measuring a three-dimensional shape of a building in particular, and is also referred to as a laser scanner or the like. Note that the measurement device 1 according to the present invention is not limited to the laser scanner, and may be, for example, a laser marking device or a rotating laser for defining a reference plane or a reference line at a time of civil engineering and construction, or a survey instrument such as a theodolite or a total station that measures distances and angles.

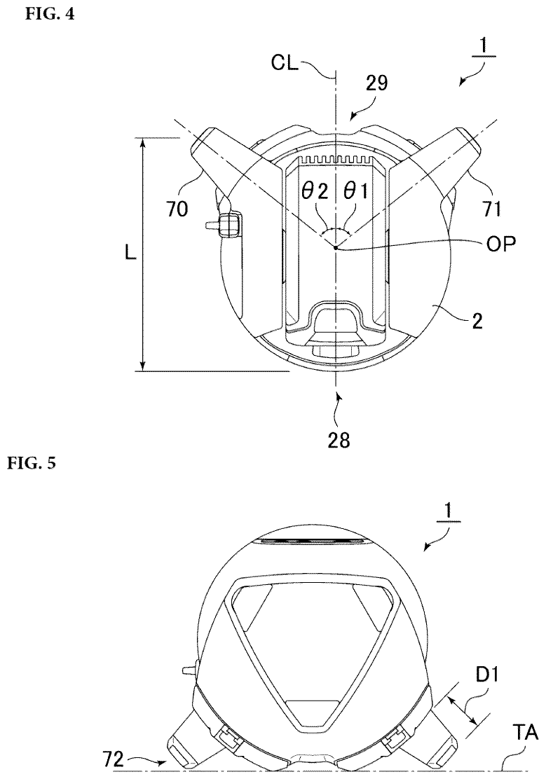

The measurement device 1 has a substantially cylindrical shape as an entire shape, and has a perfect circle shape except handles 70 and 71 and batteries 38 and 39 in plan view in a standing state (i.e., the same orientation as that at a time when the measurement device 1 is installed on a tripod and used). The measurement device 1 has a generally fixed size to enable installation and use of the measurement device 1 on the tripod. A diameter L seen from a planar face illustrated in FIG. 4 is smaller than at least an average shoulder width (approximately 39.7 cm) of men over 20 years old, and is preferably 40 to 50% of the average shoulder width. The diameter L according to the present embodiment is 18.3 cm that is approximately 46% of the average shoulder width. Note that a height H1 excluding an antenna 7 in FIG. 1 is preferably 29 to 30 cm, and the height H1 in the present embodiment is 29.8 cm.

As illustrated in FIG. 1, the measurement device 1 includes a tribrach 4, a base part 3, a measurement device main body 2, and a remote controller 5.

### [Regarding Tribrach]

The tribrach 4 is fixed onto the tripod 6, and can perform automatic leveling in a case of the present embodiment. That is, the tribrach 4 includes three leveling screws 4a, and, when an automatic leveling switch 21 (see FIG. 2) is turned on, a known program works, and the leveling screws 4a rotate, automatically adjust themselves, and incline in a random direction.

### [Regarding Base Part]

The base part 3 is connected onto the tribrach 4, and rotatably supports the measurement device main body 2 in a horizontal direction. In the case of the present embodiment, the base part 3 includes a motor 31 and a driving gear 32 that is driven by this motor 31. Furthermore, the driving gear 32 and a horizontal rotary shaft 33 that is provided projecting from the lower face of the measurement device main body 2 enmesh with each other, so that the measurement device main body 2 is rotatable in the horizontal direction (a left/right direction of the measurement device main body 2).

Furthermore, a horizontal angle detector 35 (such as an encoder) that detects a rotation angle of the horizontal rotary shaft 33 is provided in the base part 3, and thereby detects a relative rotation angle in the horizontal direction of the measurement device main body 2.

As illustrated in FIG. 2, the base part 3 is equipped with an operation unit 20 and the batteries 38 and 39.

The operation unit 20 includes a power switch 23 of the entire device, a laser centering switch 22, and the automatic leveling switch 21 in order from the right in FIG. 2. The laser centering switch 22 is used at a time of centering work, and, when the laser centering switch 22 is turned on, laser light is radiated from the bottom face of the tribrach 4 toward a floor surface or the like, so that it is possible to perform position adjustment using the radiated laser light as a guide. The automatic leveling switch 21 is a switch for performing the above-described automatic leveling.

The batteries 38 and 39 are driving power supplies that apply voltages to a laser light emitting unit 52 described later and supply power to each part, are detachable in the case of the present embodiment, yet may be a type that is charged while being fixed to the base part 3. The batteries 38 and 39 will be described later.

### [Regarding Measurement Device Main Body]

As illustrated in FIG. 1, the measurement device main body 2 includes a lens barrel part 50 that includes the built-in laser light emitting unit 52, and a bracket part 10 whose entire shape is a U shape, and rotatably supports the lens barrel part 50 inside.

The bracket part 10 includes a driving gear 12 and a motor 14 that drives this driving gear 12 inside. The driving gear 12 enmeshes with a vertical rotary shaft 16 that connects the lens barrel part 50 and the bracket part 10, so that the lens barrel part 50 is rotatable in a vertical direction (an upper/lower direction of the lens barrel part 50).

Furthermore, a vertical angle detector 18 (such as an encoder) that detects a rotation angle of the vertical rotary shaft 16 is provided in the bracket part 10, so that the relative rotation angle in the vertical direction of the lens barrel part 50 is detected.

In this way, the respective rotary shafts 16 and 33, the respective driving gears 12 and 32, and the motors 14 and 31 work together, and direct the lens barrel part 50 to the desired horizontal and vertical directions. Furthermore, the respective rotation angle detectors 18 and 35 can detect the rotation angles of rotation of the lens barrel part 50 in the horizontal and vertical directions.

Note that the bracket part 10 is provided with the wide-angle camera 19. The wide-angle camera 19 is mainly used for observation, and an image acquired by the wide-angle camera 19 is displayed on a display unit 5a of the remote controller 5. Consequently, the measurer can search for a measurement target from the display unit 5a, and select the measurement target using the remote controller 5. This wide-angle camera 19 has, for example, 30° of a wide angle of view.

Furthermore, the pair of handles 70 and 71 project from the outer face of the bracket part 10 that is part of the measurement device main body 2. The handles 70 and 71 are means for lifting or moving the measurement device 1, and is made of a plastic material such as an ABS resin having high rigidity and water resistance. The handles 70 and 71 may be a fixed type or a detachable type. These handles 70 and 71 will be described later.

The lens barrel part 50 includes the laser light emitting unit 52 and a laser light reception unit 54 that constitute a distance measurement unit inside.

The laser light emitting unit 52 includes a light emitting element, a transmitter lens, and a polarizing prism (that are not illustrated). As the light emitting element, for example, laser diodes that emit laser light can be used, and the emitted laser light transmits through the transmitter lens and the polarizing prism provided inside, and then through the transparent window part 28 on the optical axis of the laser light, and is radiated on the measurement target.

The laser light reception unit 54 includes a light reception element, a reflection polarizing prism, and an imaging lens (that are not illustrated). The light reception element is, for example, a photodiode, and reflection light reflected by the measurement target condenses on the light reception element through the reflection polarizing prism and the imaging lens. When receiving light, the light reception element converts the light into a signal to transmit to an arithmetic operation processing unit 56, and the arithmetic operation processing unit 56 measures a time taken until the laser light returns, and measures a distance by a known arithmetic operation.

This lens barrel part 50 also includes a narrow angle camera 58 that has a narrower angle of view than that of the above-described wide-angle camera 19. The narrow angle camera 58 captures the measurement target selected by the wide-angle camera 19, and an image acquired by the narrow angle camera 58 is displayed on the display unit 5a. This narrow angle image matches with a measurement range of the measurement device 1, so that the measurer can easily specify the measurement range using the display unit 5a, and direct the lens barrel part 50 toward a desired measurement target. This narrow angle camera 58 has, for example, 5° of a narrow angle of view.

Note that, when laser light is emitted horizontally, the wide-angle camera 19, the narrow angle camera 58, and the window part 28 according to the present embodiment are aligned in a row along the upper/lower direction of the device.

The optical axis of the narrow angle camera 58 and the optical axis of the laser light emitted from the laser light emitting unit 52 are parallel, and the center of the image of the narrow angle camera 58 and the optical axis of the laser light are matched by a known arithmetic operation.

Furthermore, a control unit (not illustrated) electrically connected with the arithmetic operation processing unit 56 specifies an emission direction angle of the laser light (distance measurement light) based on detection results of the vertical angle detector 18 and the horizontal angle detector 35, and calculates three-dimensional data (X, Y, and Z) of the measurement target according to a known program based on a result of the above distance measurement. Furthermore, it is possible to associate three-dimensional data of a measurement point and a narrow angle image, and display the narrow angle image acquired by the narrow angle camera 58 as an image with the three-dimensional data on the display unit 5a of the remote controller 5.

### [Regarding Remote Controller]

The remote controller 5 can communicate with the measurement device main body 2 by means of a wireless LAN or the like via the antenna 7, and remotely operate the measurement device 1, and a dedicated terminal or a smartphone that stores the known program is used therefor. The display unit 5a of the remote controller 5 according to the present embodiment displays images captured by the above-described wide-angle camera 19 and narrow angle camera 58, and the display unit 5a has a touch sensor function, so that it is possible to touch the screen and move the lens barrel part 50 or the bracket part 10 while checking these images, and, moreover, select or capture the measurement target.

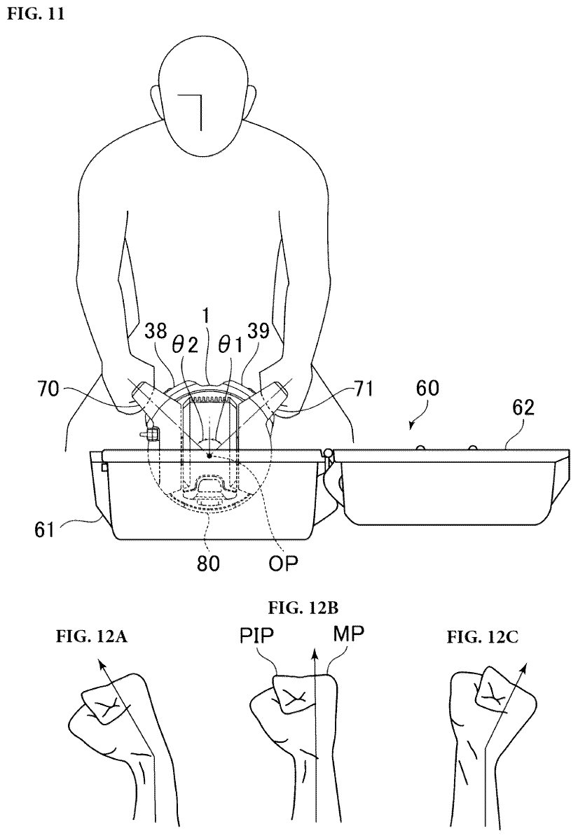

The above measurement device 1 that is a laser product is precision machinery, and is housed in a housing case 60 illustrated in, for example, FIG. 10 when not used. The housing case 60 includes a case main body 61 and a lid body 62 whose height is lower than the case main body 61 (also see FIG. 11). The case main body 61 and the lid body 62 have a protection member 63 inside such as a cushion member in which a recess part 40 matching the outer shape of the measurement device 1 is formed. In FIG. 10, a recess part 40a of the case main body 61 has a shape matching with a half body on the front face side of the measurement device 1, and a recess part 40b of the lid body 62 has a shape matching with a half body on the back face side of the measurement device 1. In this way, the inner face of the recess part 40a of the case main body 61 and the inner face of the recess part 40b of the lid body 62 are closely adhered to the measurement device 1 in a closed lid state to protect the measurement device 1.

Note that the front face (the face in FIG. 2) on which the window part 28 and the respective lenses of camera 19 and 58 whose damages cause critical defects is usually directed downward as illustrated in FIG. 10, and the case main body 61 of the protection member 63 thicker than the lid body 62 protects the front face side arranged the window part 28 and the respective lenses of camera 19 and 58 of the measurement device 1. Therefore, when the lid body 62 is opened to take out the measurement device 1 as illustrated in FIG. 10, the back face opposite to the front face is exposed.

The measurement device 1 according to the present embodiment is configured as described above, and, moreover, have following features.

### [Regarding Handles]

The handles 70 and 71 employ the same configuration except arrangement, and therefore only the configuration of the handle 71 will be described hereinafter unless otherwise mentioned in particular.

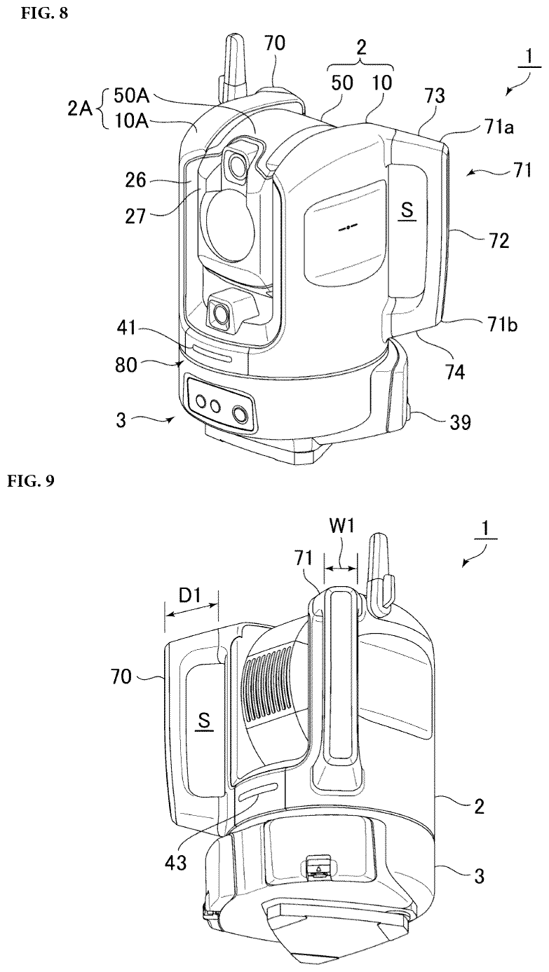

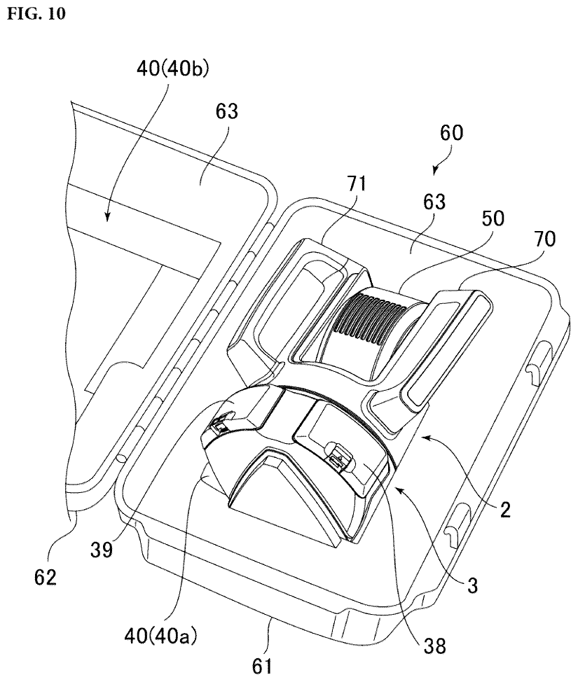

As illustrated in FIGS. 8 and 9, the handle 71 is a vertical-type handle of a substantially C shape that includes bent parts 71a and 71b at two portions as a whole, and includes a grip part 72 that is gripped by the hand and the fingers, and upper and lower support arm parts 73 and 74 that make the measurement device main body 2 support the grip part 72.

Furthermore, the grip part 72 has a width D1 that does not project outward compared to the back face center. That is, the grip part 72 is located closer to the front face side than a tangential line TA (see FIG. 5) of the back face center in the measurement device 1 that is substantially circular in plan view such that the grip part 72 is not difficult to grip apart from the center of mass of the measurement device 1. The width D1 in FIG. 9 is 5.3 cm.

Between the grip part 72 and a housing of the measurement device main body 2, there is an insertion space S in which the hand and the fingers with the glove on can be inserted. Furthermore, the grip part 72 has a width dimension W1 (see FIG. 12 for joint positions) that matches with dimensions between joints MP (metacarpal phalangeal joints) of the bases of the fingers except the thumb, and second joints PIP (proximal interphalangeal joints) from the distal ends of the fingers, so that it is possible to bend the joints of the above fingers and grip the grip part 72 with the glove on.

As illustrated in FIGS. 2 to 4, the handles 70 and 71 project apart from each other toward the back face side opposite to the wide-angle camera 19 along a radial direction from a horizontal direction center OP in the standing state of the measurement device main body 2. Therefore, in a state where the measurement device 1 is laid in the housing case 60 with the front face side facing downward as illustrated in FIG. 10 to protect the window part 28 and the respective lenses of camera 19 and 58, the handles 70 and 71 are located above. Consequently, the handles 70 and 71 are located above when the measurer bends forward to take out the measurement device 1 from the housing case 60 (see FIG. 11), so that the measurer can grip the handles 70 and 71 bending forward shallowly, and reduce a physical burden on the waist upon bending forward.

Furthermore, in the standing state of the measurement device 1 whose entire shape is the cylindrical shape, the handle 70 and the handle 71 are arranged at a range of 40 to 45 degrees to the left and the right, respectively, from the horizontal direction center OP of the measurement device main body 2 as illustrated in FIG. 4. More specifically, assuming as a reference a center line CL that passes through the horizontal direction center OP and a back face part 29 (i.e., back face center) exact opposite to the window part 28 in plan view illustrated in FIG. 4, the one handle 70 is arranged at a center angle 02 of 40 to 45 degrees, and the other handle 71 is also arranged at a center angle 01 of 40 to 45 degrees.

Consequently, when a Japanese man who is over 20 years old and whose average height is 172 cm takes a posture to bend forward lowering the waist as illustrated in FIG. 11, and grips the handles 70 and 71 on the inner side of the shoulder width while substantially vertically dropping the upper arms, the man can hold the measurement device 1 without bending the wrists. That is, in a state where the man grips the handles, the man does not bend the wrists forward as in FIG. 12(a) or backward as in FIG. 12(c), and the forearms to the fists are straight as illustrated in FIG. 12(b), so that it is possible to the most effectively exhibit the gripping force. Naturally, although the fist is not in the state in FIG. 12(b) at all times due to individual characteristics of the measurer such as the height, the posture, or habits, it is possible to roughly adjust the posture such as clenching of or the measure's sides or arm angles without a hardship, and the handles 70 and 71 can play a role of guides that guide the fists to the state in FIG. 12(b).

Note that the angle θ1 on the right side and the angle θ2 on the left side are the same in the case in FIG. 11, and are respectively set to 45 degrees.

Furthermore, on a face of the handle 71 that is exposed outward, that is, a face opposite to the insertion space S in which the fingers are inserted, a mark having the highest brightness in the measurement device main body 2 is arranged. Consequently, when the measurement device 1 is taken out from the housing case 60 by opening the lid body 62 as illustrated in FIG. 10 at a relatively dark place such as a dim room, it is easy to find the handle 71, and it is possible to quickly resolve a state where the measurer deeply bends the waist.

### [Regarding Swelled Part]

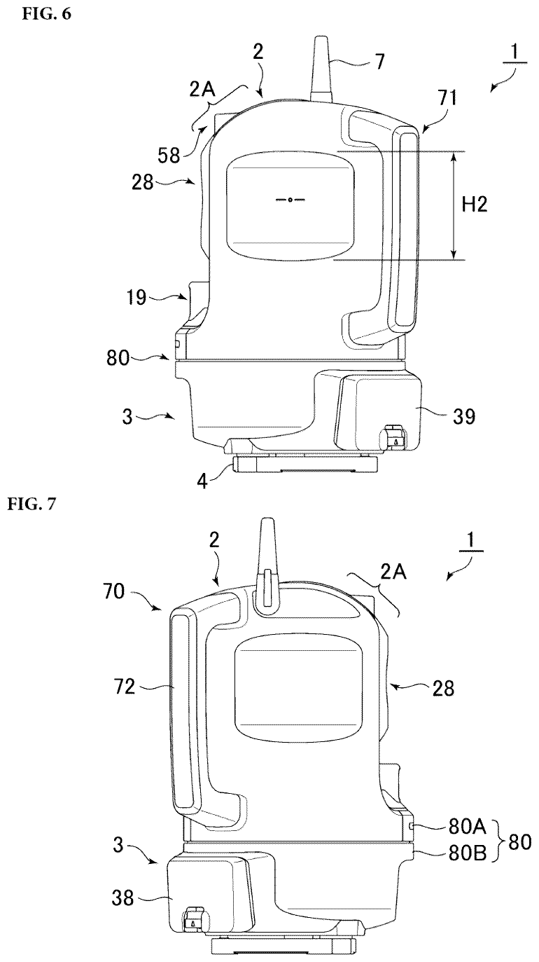

As illustrated in FIGS. 6 and 7, a swelled part 80 that is swelled toward the frontmost side is formed on the front face side opposite to the handles 70 and 71 of the measurement device main body 2. In the case of the present embodiment, in the standing state of the measurement device 1, the front face side of the measurement device main body 2 is dented by chamfering the center part to the upper side, and the front face side of the base part 3 is dented across the center part and the lower side to form the swelled part 80.

Furthermore, in the standing state of the measurement device 1, the handles 70 and 71 and the batteries 38 and 39 have different positions in the upper/lower direction with the swelled part 80 serving as a reference (boundary). In the case of FIGS. 6 and 7, the handles 70 and 71 are arranged on the upper face side (the planar face side in FIG. 4) of the swelled part 80, and the batteries 38 and 39 are arranged on the lower face side (the bottom face side in FIG. 5) of the swelled part 80.

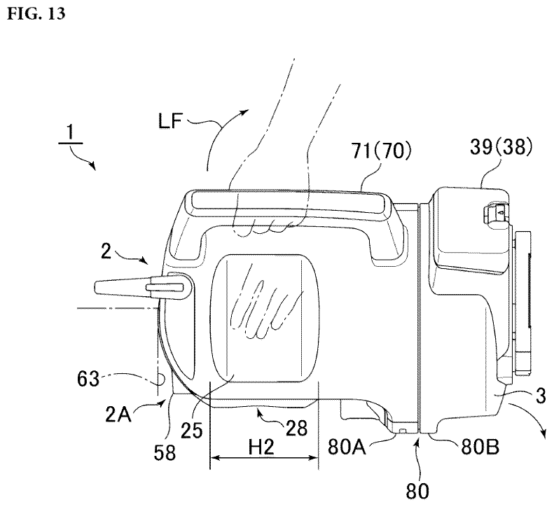

Consequently, when the measurement device 1 is taken out from the housing case in a state in FIG. 13 (the housing case is not illustrated) where the measurement device 1 is laid with the front face side facing downward, and when the handle 71 is lifted, the force acts with the heavy battery 39 side facing downward, the swelled part 80 serves as a pivot point, and the handle 71 side turns upward toward LF according to the principle of leverage and becomes easy to lift, so that it is possible to suppress a degree to apply the force in a state where the waist is bent.

Furthermore, the present embodiment has following further features to make it easy to lift the measurement device 1.

### [Further Feature 1]

First, in the standing state illustrated in FIG. 3, the respective left and right batteries 38 and 39 are arranged just below the respective left and right handles 70 and 71. In FIG. 3, the right battery 38 is arranged below the right handle 70, and the left battery 39 is arranged below the left handle 71. Consequently, it is possible to make it easy to lift the heavy measurement device 1 by shifting the center of mass toward the side of the handles 70 and 71 as much as possible. The battery 38 and the battery 39 preferably have the same weight.

### [Further Feature 2]

Next, as illustrated in FIGS. 3 and 13, dented parts 25 are formed on respective left and right side faces of the measurement device main body 2 (left and right side faces of the bracket part 10 in the present embodiment). The dented parts 25 are guides for easily guiding the hands and the fingers wearing the gloves to the spaces S between the handles 70 and 71 and the left and right side faces of the measurement device main body 2. More specifically, in the standing state of the measurement device 1, a height H2 (that is the horizontal width in the laid state in FIG. 13. Also see FIG. 6) matching the four fingers except the thumb with the glove on matches with the width of the four fingers except the thumb with the glove on. Furthermore, this dented part 25 is arranged across the center part and the upper side (the planar face side in FIG. 4) (i.e., a side closer to the upper side of the side face meeting the space S) of the measurement device main body 2. Consequently, as illustrated in FIG. 13, the measurer is guided to the dented part 25 having this spatial margin, grips the farthest positions of the handles 70 and 71 from the batteries 38 and 39, and easily rotates the handles 70 and 71 in the LF direction according to the principle of leverage.

Note that providing the handles 70 and 71 only at the upper side (the planar face side in FIG. 4) from the beginning makes it possible to obtain the similar effect to that of the present embodiment, yet makes an operation difficult since the handles are located only above when the measurement device 1 is placed on a tall tripod and fixed. Therefore, preferably, in the standing state in FIG. 3, the handles 70 and 71 are arranged widely across the upper part and the lower part of the measurement device main body 2, and the dented parts 25 that serve as the guides for guiding the fingers have the height H2 at which the four fingers with the gloves on are inserted with the upper part of the space S serving as the reference.

### [Further Feature 3]

Next, as illustrated in FIGS. 6 to 8, the measurement device main body 2 has an area 2A on the front face side of the upper face (the face seen from the planar face in FIG. 4) in the standing state as a curved inclined face that inclines downward and has a shape protruding outward. More specifically, areas 50A and 10A (see FIG. 8) on the front face side of the upper faces of both of the lens barrel part 50 and the bracket part 10 are curved inclined faces curved similar to the above. Consequently, when the measurement device 1 is turned in the LF direction using the swelled part 80 as the pivot point to take out from the housing case the measurement device 1 laid in the housing case with the front face side having the window part 28 facing downward as illustrated in FIG. 13, it is possible to prevent the measurement device main body 2 from getting caught by the protection member 63 of the housing case, and smoothly take out the measurement device 1 from the housing case.

Note that only the narrow angle camera 58 does not have a curved inclined face because the optical axis of the narrow angle camera 58 and the optical axis of laser light emitted from the laser light emitting unit 52 need to be made parallel, and a case where part of the components do not include the curved inclined faces is also covered by the present invention.

### [Further Feature 4]

Next, as illustrated in FIGS. 2 and 8, the lens barrel part 50 and the bracket part 10 have faces 26 and 27 that continue to the front face side around a boundary between the lens barrel part 50 and the bracket part 10. These “continuing faces” refer to a state where, while the lens barrel part 50 and the bracket part 10 are not closely adhered and therefore there is a space at the boundary, the respective faces 26 and 27 are close to each other as if the vicinity of the boundary between the respective faces 26 and 27 were coplanar. The faces 26 and 27 are formed to continue in this way to avoid the measurement device 1 from getting caught as much as possible when the measurement device 1 is taken out from the housing case.

Note that the above continuing faces have a shape from which the front face side of the measurement device main body 2 whose entire shape is the cylindrical shape has been flatly cut out. Consequently, the measurer easily grasps the front face compared to the case where the entire shape is the substantially cylindrical shape.

In this regard, in a case where the lens barrel part 50 and the bracket part 10 have the faces 26 and 27 that continue to the front face side as described above, it is difficult to visually check the boundary between the lens barrel part 50 and the bracket part 10 when the device is seen from afar during a remote operation or the like. Moreover, in the first place, the lens barrel part 50 does not protrude from the bracket part 10 as much as possible in the present embodiment. Therefore, this configuration has difficulty in grasping a motion of the lens barrel part 50. Hence, the present embodiment includes following further features to easily grasp the motion of the lens barrel part 50.

### [Further Feature 5]

First, as illustrated in FIGS. 8 and 9, the measurement device 1 includes indicators 41 and 43 including LEDs or the like that are turned on when the lens barrel part 50 rotates. The indicators 41 and 43 are arranged on the outer face of the bracket part 10, and on the lower side below the lens barrel part 50. The indicators 41 and 43 in in FIGS. 8 and 9 are arranged on the front face and the back face, and are turned on with the same color, yet may be turned on with different colors between the front face and the back face or may be turned on by different methods such as flashing or the like to enable distinction between the front face and the back face.

### [Further Feature 6]

Next, in the present embodiment, a continuous pattern whose pattern is misaligned by rotation of the lens barrel part 50 is applied across the lens barrel part 50 and the bracket part 10.

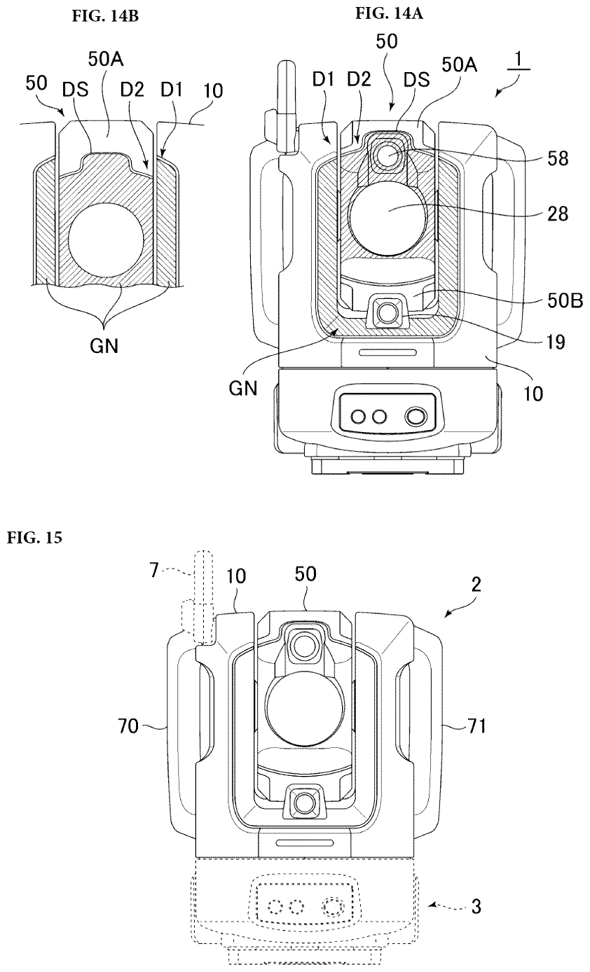

FIG. 14 is a view for describing this continuous pattern, FIG. 14(A) is a view of a non-driven state, and FIG. 14(B) is a view illustrating that the lens barrel part 50 rotates downward.

There is a space between the lens barrel part 50 and the bracket part 10 as illustrated in FIG. 14(A), and, in the non-driven state, a pattern D2 of the lens barrel part 50 on the bracket part 10 side and a pattern D1 of the bracket part 10 on the lens barrel part 50 side approach each other to form a continuous pattern DS.

The continuous pattern DS in FIG. 14 is a line or a belt shape applied from the lens barrel part 50 to the bracket part 10, and has a ring shape surrounding the window part 28 and the cameras 19 and 58. Hence, when the lens barrel part 50 rotates in the vertical direction, a line/belt D2 of the lens barrel part 50 and a line/belt D1 of the bracket part 10 are separated, and the continuous pattern collapses as illustrated in FIG. 14(B), so that it is possible to grasp the motion of the lens barrel part 50. Note that the continuous pattern DS has a uniform color, and is yellowish so as to be distinctive even when the line/belt has the narrow width.

### [Further Feature 7]

Next, an inner area GN (an area applied parallel diagonal lines in FIG. 14) surrounded by the ring-shaped continuous pattern DS has a different color from the continuous pattern DS, and has a uniform color except in upper/lower areas (i.e., an area on the front face side on the upper face and an area on the front face side on the lower face) 50A and 50B of the lens barrel part 50.

The color of this inner area GN is preferably far from the color of the continuous pattern DS, the continuous pattern DS in the present embodiment is yellowish, and therefore this inner area GN is blackish except in the upper/lower areas 50A and 50B of the lens barrel part 50. Note that the upper/lower areas 50A and 50B of the lens barrel part 50 have a different color from those of the continuous pattern DS and the inner area GN, preferably has an intermediate hue of the color of the continuous pattern DS and the color of the inner area GN, and is silver in FIG. 14.

The inner area GN surrounded by the continuous pattern DS is formed as described above. Therefore, when the lens barrel part 50 rotates downward as in FIG. 14(B), while the blackish color of the inner area GN on the bracket part 10 side does not move, the silver color of the upper area 50A of the lens barrel part 50 moves increasing from above, and, by contrast with this, when the lens barrel part 50 rotates upward, the silver color of the lower area 50B of the lens barrel part 50 moves increasing from below, so that it is easy to grasp the motion in the upper/lower direction, too.

The present invention is not limited to the above embodiment, and can be variously modified without departing from the claims.

For example, in FIGS. 1 to 9, the swelled part 80 is arranged on the front face equipped with the wide-angle camera 19, and the handles 70 and 71 are arranged on the back face opposite to the wide-angle camera 19. However, a positional relationship between the swelled part 80 and the handles 70 and 71 is relative with the horizontal direction center OP serving as the reference, and the wide-angle camera 19 does not necessarily serve as the reference for determining the front face and the back face.

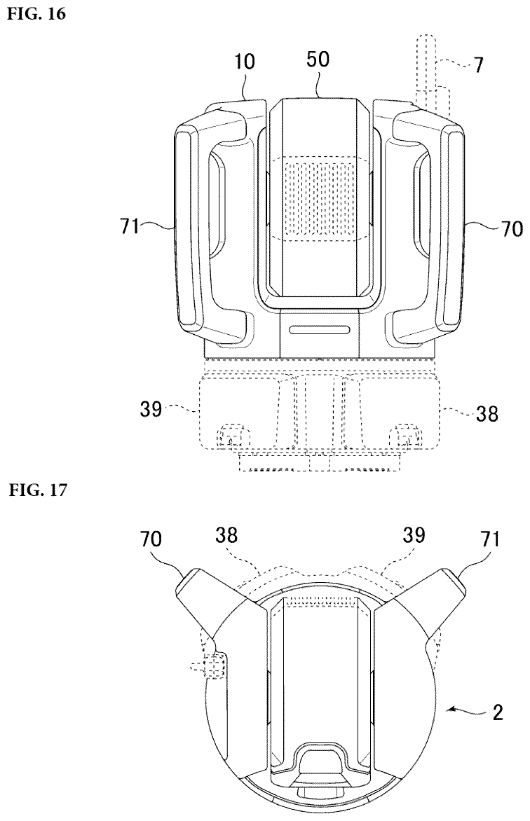

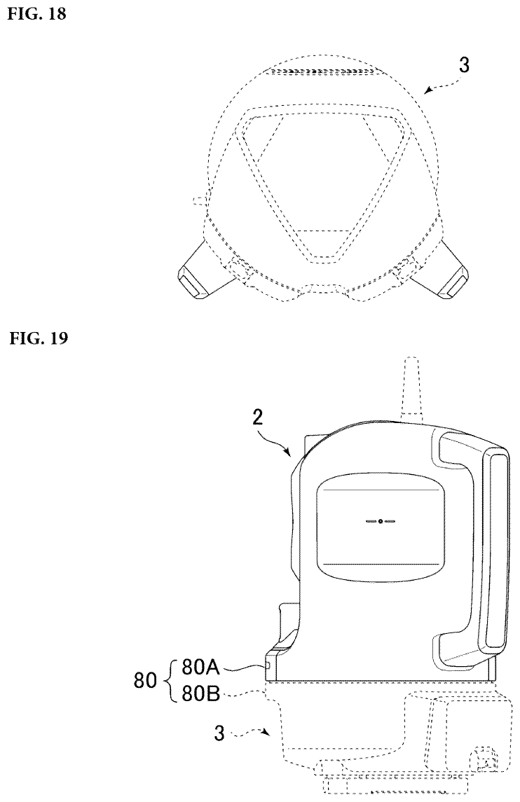

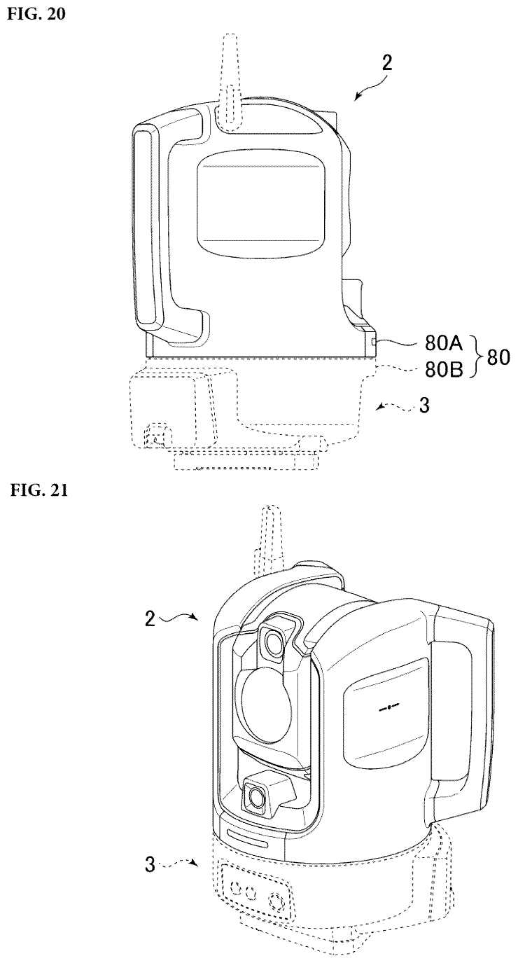

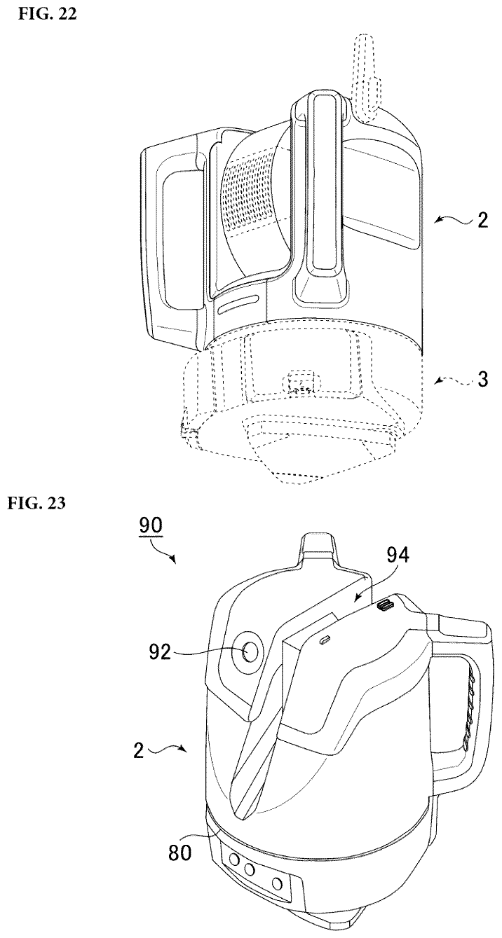

Furthermore, as for areas indicated by broken lines in FIGS. 15 to 22, the antenna 7 may be a built-in type or may not be equipped. Furthermore, the batteries 38 and 39 may be collectively one battery. Furthermore, the swelled part 80 in FIG. 7 includes a swelled part 80A on the measurement device main body 2 side, and a swelled part 80B on the base part 3 side. However, the present invention is not limited to this, and only the swelled part 80A on the measurement device main body 2 side may be the swelled part 80, and the swelled part may not be formed at the base part 3.

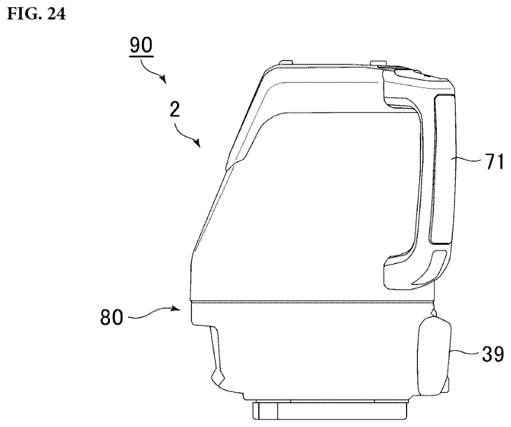

Alternatively, according to the above embodiment, the upper side of the swelled part 80 of the measurement device main body 2 is dented so as to form a substantially vertical flat face as illustrated in FIG. 6. However, as in a measurement device 90 illustrated in FIGS. 23 and 24 according to the modified example, the upper side of the swelled part 80 of the measurement device main body 2 may be an inclined face that narrows toward the upper face of the outer shape of the measurement device main body 2.

Note that, according to the measurement device 1 in FIGS. 1 to 9, the entire lens barrel part 50 rotates in the vertical direction, and the window part 28 also rotates. However, the measurement device 90 in FIGS. 23 and 24 have as a transparent window part an entire face that is exposed toward an outer side of a lens barrel part 94, and a laser light emitting unit inside the window part rotates in the vertical direction and emits laser light. Furthermore, a camera 92 of the measurement device 90 has two functions of a wide-angle camera and a narrow angle camera. The above configuration is also covered by the present invention.

### REFERENCE SIGNS LIST

1, 90 Measurement device
2 Measurement device main body
2A Curved inclined face
3 Base part
10 Bracket part
25 Dented part
38, 39 Battery
50 Lens barrel part
52 Laser light emitting unit
70, 71 Handle
80 Swelled part
OP Horizontal direction center
DS Continuous pattern

1. A measurement device comprising:
a measurement device main body that includes a laser light emitting unit that emits laser light for measurement;
a base part that rotatably supports the measurement device main body in a horizontal direction; and
handles that project from the measurement device main body, wherein
the handles project apart from each other toward left and right sides of a back face along a radial direction from a center of the horizontal direction in a standing state of the measurement device main body, direction,
a swelled part that swells toward a frontmost side is formed on a front face side opposite to the handles of the measurement device main body, and
in the standing state, the handles and batteries that apply voltages to the laser light emitting unit have different positions in an upper/lower direction with the swelled part serving as a reference.

2. The measurement device according to claim 1, wherein
the handles are arranged from the swelled part to an upper face side regarding a vertical position in the standing state, and
the front face side of the upper face of the measurement device main body in the standing state is a curved inclined face that inclines downward and has a convex shape outward.

3. The measurement device according to claim 2, wherein
the measurement device main body includes a lens barrel part at which the laser light emitting unit is arranged, and a bracket part that rotatably supports the lens barrel part in a vertical direction,
the lens barrel part and the bracket part have faces that continue to a front face side around a boundary between the lens barrel part and the bracket part, and
a continuous pattern is applied across the lens barrel part and the bracket part.

4. The measurement device according claim 1, wherein the batteries are arranged just below the respective handles on the left and the right in the standing state.

5. The measurement device according to claim 1, wherein
dent parts that serve as guides for guiding hands wearing gloves to the handles are formed on left and right-side faces of the measurement device main body; and
the dent parts have a height matching four fingers except thumbs with the gloves on in the standing state, and are arranged across a center part and an upper side of the measurement device main body.

6. The measurement device according to claim 2, wherein the batteries are arranged just below the respective handles on the left and the right in the standing state.

7. The measurement device according to claim 3, wherein the batteries are arranged just below the respective handles on the left and the right in the standing state.

8. The measurement device according to claim 2, wherein
dent parts that serve as guides for guiding hands wearing gloves to the handles are formed on left and right-side faces of the measurement device main body; and
the dent parts have a height matching four fingers except thumbs with the gloves on in the standing state, and are arranged across a center part and an upper side of the measurement device main body.

9. The measurement device according to claim 3, wherein
dent parts that serve as guides for guiding hands wearing gloves to the handles are formed on left and right-side faces of the measurement device main body; and
the dent parts have a height matching four fingers except thumbs with the gloves on in the standing state, and are arranged across a center part and an upper side of the measurement device main body.
